(19) United States
(12) Patent Application Publication
(10) Pub. No.: US 2012/0109521 A1
(43) Pub. Date: May 3, 2012

(54) SYSTEM AND METHOD OF INTEGRATING LANE POSITION MONITORING WITH LOCATIONAL INFORMATION SYSTEMS

(75) Inventor: Leigh M. Rothschild, Sunny Isles Beach, FL (US)

(73) Assignee: Reagan Inventions, LLC, Sunny Isles Beach, FL (US)

(21) Appl. No.: 13/272,752

(22) Filed: Oct. 13, 2011

Related U.S. Application Data
(60) Provisional application No. 61/407,183, filed on Oct. 27, 2010.

(51) Int. Cl. G01C 21/34; G01C 21/36; G08G 1/0967

(52) U.S. Cl. 701/487; 340/905; 701/408; 701/523

(57) ABSTRACT

A system and method for an integrated lane positioning monitor with locational information systems is provided. The system and method gather and process information and data to assist an automobile operator in selecting and changing driving lanes. Further, the system and method is integrated with a locational information system to inform the operator of upcoming congestion and traffic issues as well as an appropriate distance to change lanes before a highway exit or entrance.

This application claims priority on U.S. Provisional Application No. 61/407,183 filed on Oct. 27, 2010.

### BACKGROUND

1. Field

A system and method are provided to enhance current lane departure warning systems with lane-level position information that can be integrated with GPS navigation functionality to enable enhanced lane guidance.

2. Description of the Related Art

Current GPS systems give directions and traffic alerts but do not indicate a vehicle's lane position on a roadway or utilize that information to further assist a vehicle operator with directional information.

Commercial GPS devices (e.g., TomTom GO 950) provide lane guidance to indicate the appropriate lane to be in for an upcoming exit or turn but cannot detect the lane the vehicle occupies and recommend the required lane changes at appropriate distances from the impending exit or turn. Lane-level positioning capability integrated with the GPS device can create a lane-level navigation system to advise the driver which lane should be chosen to reach the specified destination without requiring excessive last-minute lane changing.

In road-transport terminology, a Lane Departure Warning (LDS) system is a mechanism designed to warn a driver when the vehicle begins to move out of its lane without utilizing a turn signal on freeways and arterial roads. These systems are designed to minimize accidents by addressing the main causes of collisions: driving error, distraction, and drowsiness. In 2009, the NHTSA began studying whether to mandate lane departure warning systems and frontal collision warning systems on automobiles. Currently, there are two main types of lane departure warning systems: systems which warn the driver if the vehicle is leaving its lane with visual, audible, and/or vibration signals, and systems which warn the driver and automatically take corrective actions if the driver fails to respond to the warnings.

The first production lane departure warning system in Europe was developed by the Iteris, Inc. for Mercedes Actros commercial trucks in 2000 and is now available on most trucks sold in Europe. In 2002, the Iteris system became available on Freightliner Trucks vehicles in North America. In these systems, the driver is warned of unintentional lane departures by an audible rumble strip sound generated on the side of the vehicle drifting out of the lane. If a turn signal is used, no warnings are generated.

Most lane departure systems rely on optics and sensors to determine a vehicle's position relative to road markings. In 2005, the combined effort of Visteon and University of Michigan Transportation Research Institute (UMTRI) integrated radar and other technology to provide a more comprehensive driver assistance system. Dubbed “Road Departure Crash Warning” (RDCW) technology, the system warns drivers drifting out of their lane and helps drivers adjust speed for negotiating curves.

The RDCW system provides two distinct modes of driver warning that are designed to minimize nuisance and gain credibility with the driver for the time when a road departure warning is truly needed. The first type of warning is to prevent the drift-off-road problem that arises from inattention or drowsiness. A second type of warning is to alert a person who is driving too fast for an upcoming curve. The RDCW system does not intervene in vehicle control.

UMTRI's “lateral drift warning” function operates in similar fashion to other lane departure warning systems in that it relies on a forward-looking video camera in order to measure vehicle position and lateral velocity relative to lane and road-edge markings. However, the system adds another layer of sophistication through the use of four radar units mounted in the front fascia and side of the vehicle. These forward and side facing radar units assess the room available on the shoulder for performing a recovery maneuver. When ample room is present, warnings are delayed to avoid nuisance alarms that often result from early warnings. However, when little room is available, the warnings are given early so that the driver has enough time to respond and avoid a crash.

When drift-off is detected, the system provides audio, visual, and seat vibration warnings. Drivers receive either a cautionary or imminent alert, based on lane position, lateral movement, and the type of lane boundary. A cautionary alert occurs when the driver is crossing a dashed-line boundary with no vehicles in the drift path. The alert appears as a yellow icon on the dashboard display and as a vibration on the left or right side of the driver's seat, depending on the direction of lateral drift. An imminent alert occurs when the driver approaches or has crossed a solid-line boundary or when crossing a dashed-line boundary while a vehicle is present in the drift path. A red icon appears on the display and a buzz sounds on the side of the vehicle at which the threat is developing.

The system becomes inactive in the following conditions: on unpaved roads, roads with poor lane markings or badly defined road edges, and at speeds below 25 mph. Warnings are not issued when a lane change is preceded by a driver engaging a turn signal.

On the UMTRI test vehicles, more than 300 channels of data are collected every tenth of a second, including vehicle speed, lane position, location of lane and road edges and objects around the vehicle, plus many signals indicating the driver's actions and the state of the vehicle. Data are gathered from radar sensors pointing toward the front and sides of the vehicle, video cameras pointed through the windshield and at the driver's face, and by means of several other instruments that monitor the motion of the vehicle and whether a cell phone is in use. The data acquisition system automatically sends a data sample from the vehicle to the UMTRI facility, via a cell modem, each time the ignition is turned off. A comment button, installed in the dashboard, allows drivers to record comments and suggestions any time they drive.

Vision based lane recognition systems are relatively mature and have already been introduced to market for lane departure warning and other systems. However, both systems have some limitations.

### SUMMARY

A system and method for an integrated lane positioning monitor with locational information systems is provided. The system and method gather and process information and data to assist an automobile operator in selecting and changing driving lanes. Further, the system and method is integrated with a locational information system to inform the operator of upcoming congestion and traffic issues as well as an appropriate distance to change lanes before a highway exit or entrance.

In one aspect of the present invention, a method for integrating a locational information system with a lane position monitor is provided. The method includes transmitting a series of driving directions to a vehicle operator via a locational information system based on a destination inputted by the operator. The driving directions may be transmitted by audible sounds and visual indications.

The method further includes processing image and data captured by at least one sensor to determine which particular lane of a series of lanes a vehicle occupies on a roadway. The step of the method may include taking a series of photographs to determine lane markings substantially parallel to the vehicle and further determine the number of lanes on a roadway on each side of the vehicle.

The method also includes determining an appropriate lane that should be occupied based on a particular driving direction and comparing the appropriate lane to the occupied lane.

In another aspect of the invention, the method includes analyzing vehicle speed, location, and distance from a position where the operator must make a maneuver, such as a turn, and determining the appropriate position for a lane change based on the location and speed of the vehicle. The method also includes determining whether vehicles in adjacent lanes would interfere in the ensuing lane change. In an instance where a vehicle must make multiple lane changes to enter the appropriate lane, the method includes determining multiple positions for the multiple lane changes.

In another aspect of the invention, the method includes transmitting at least one lane switch direction to the vehicle operator at a distance before the maneuver is to be completed.

The invention also relates to a system for providing lane positioning information is provided. The system includes a locational information system, such as a Global Positioning System (GPS), to determine the vehicle's position within a network of roadways. The locational information system provides a vehicle operator with detailed driving directions based on a desired destination inputted by the operator. In some instances, the locational information system will also provide real time road congestion, traffic, and construction information received from a local or national network.

The system also includes a lane position monitor having at least one lane position sensor to determine a vehicle's relative position on a roadway. In the preferred embodiment, the at least one lane positioning sensor comprises several cameras mounted on a front position and on sides of the vehicle. The cameras take photographs of lane markings at predetermined intervals. In other embodiments, the sensor can be in the form of radars, lasers, and other known devices. Further, the system includes at least one sensor to determine if an adjacent lane is occupied by one or more vehicles that could interfere with driving maneuvers.

A computer is provided and is in communication with the locational information system and the cameras. Digital image acquisition software is provided on the computer. The digital image acquisition software analyzes images from the cameras and tracks the continuity of the lane markings. The digital image acquisition software determines the lane the vehicle occupies based on the relative position of lane markings on the road.

The locational information system informs the operator when appropriate driving maneuvers are necessary by giving audio and visual warnings. For instance, the locational information system may announce, “Exit right in one mile” when the driver is one mile from a highway exit. The locational information system also monitors the vehicle speed.

The computer analyzes the locational information system data along with the images captured by the digital image acquisition software to determine whether the operator is in the appropriate lane for an upcoming driving maneuver and inform the operator if and when a lane switch is necessary. For instance, if the operator is required to use an exit ramp on the right of the highway in one mile, the operator should enter the right lane at a comfortable distance before the exit. If the operator occupies the left lanes, the computer will recognize the vehicle's position and compute an appropriate time and position to change lanes based on the distance to the exit calculated by the locational information system, and inform the driver of this information.

### BRIEF DESCRIPTION OF THE DRAWINGS

The above and other aspects, features, and advantages of the disclosure will become more apparent in the light of the following detailed description when taken in conjunction with the accompanying drawings in which:

FIG. 1 is a schematic illustration of a system for integrating lane position monitoring with locational information system.

FIG. 2 is a perspective view of a vehicle utilizing the integrated lane position monitoring and locational information system.

FIG. 3 is a top plan view of a vehicle utilizing the integrated lane position monitoring and locational information system on a multi-lane roadway.

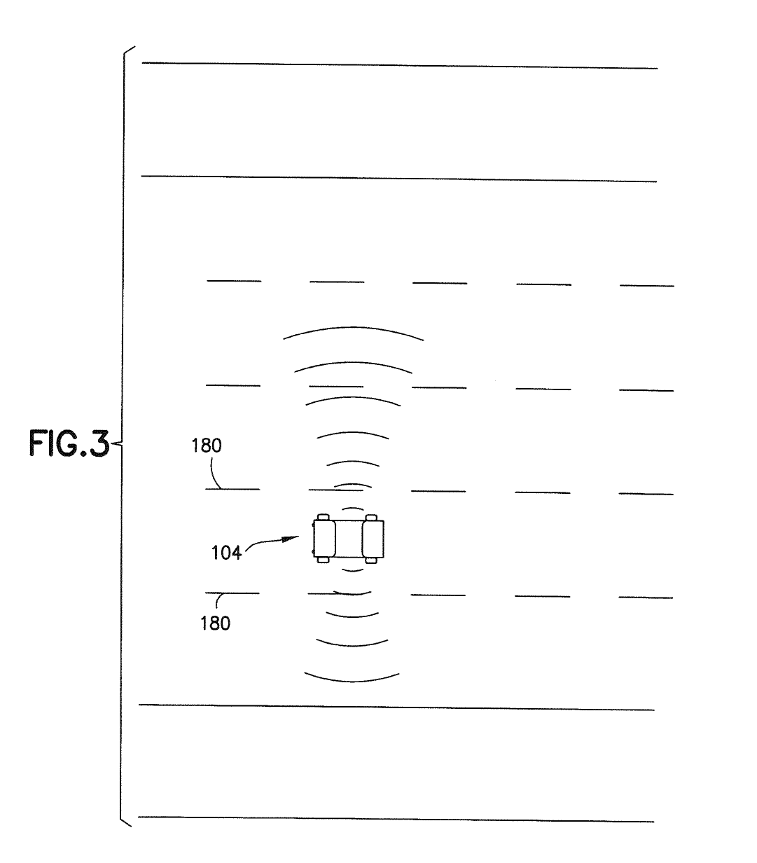

FIG. 4 is a flow chart illustrating a method for integrating lane position monitoring with locational information system.

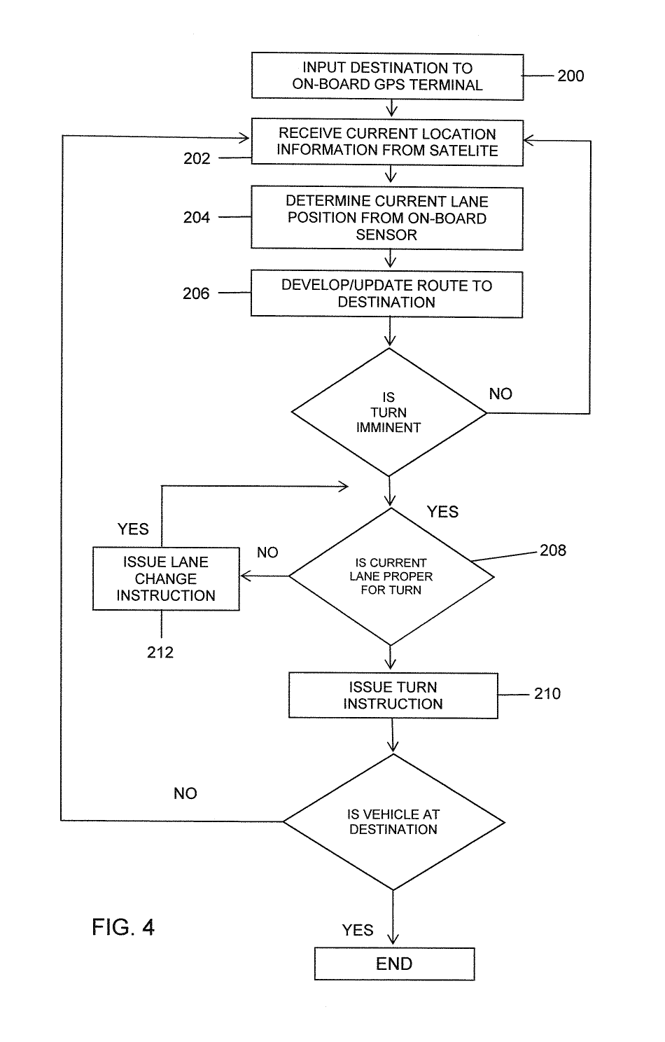

### DETAILED DESCRIPTION

Preferred embodiments of the disclosure will be described herein with reference to the accompanying drawings. In the following description, well-known functions or constructions are not described in detail to avoid obscuring the disclosure.

Embodiments of the present disclosure overcome the shortcomings of existing practices and provides a system and method for integrating lane position monitoring and locational information systems.

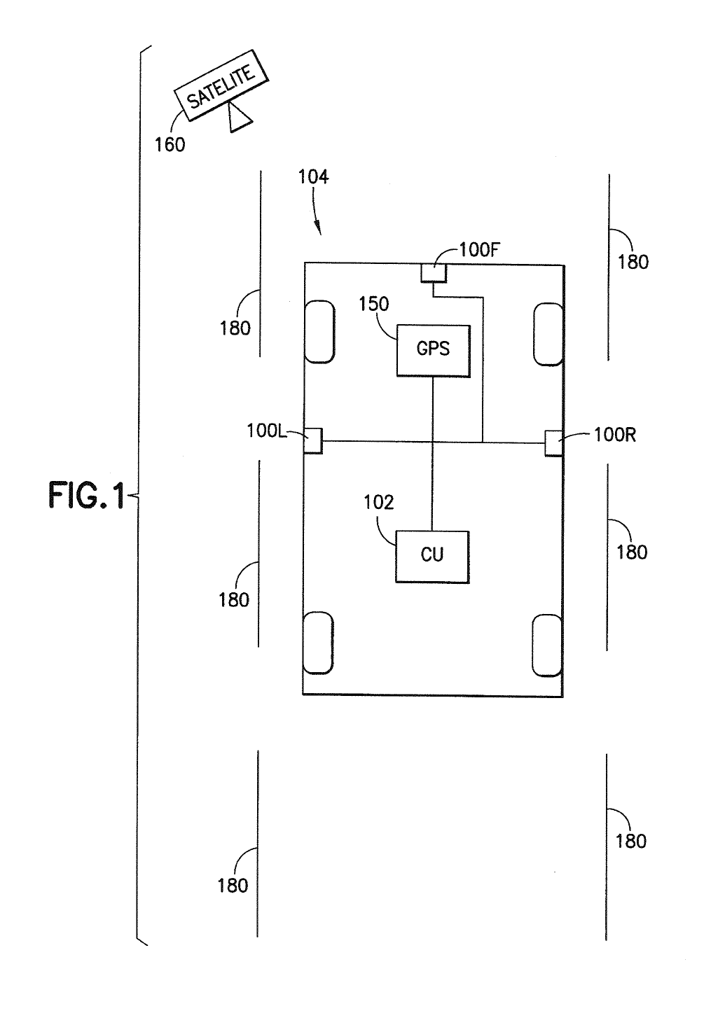

Referring to FIG. 1, a system for integrating lane position monitoring devices with locational information includes a lane positioning monitoring sensors 100 connected to a computer processor 102, e.g., a microprocessor, central processing unit, etc., both of which are connected via a mounted on a vehicle 104 and configured to identify and record lane marking information. The computer processor 102 is configured to analyze the lane marking information from the sensors 100 to determine the relative position of the vehicle 104 on a roadway.

The computer processor 102 will use computer software instructions that have been programmed into the computer processor 102 and conventional computer processing power to interact and organize the traffic flow between the various other modules, sensors, etc. of the vehicle. It is to be understood that the present disclosure may be implemented in various forms of hardware, software, firmware, special purpose processors, or a combination thereof. A system bus 104 couples the various components shown in FIG. 1 and may be any of several types of bus structures including a memory bus or memory controller, a peripheral bus, and a local bus using any of a variety of bus architectures. The device also includes an operating system and micro instruction code preferably residing in read only memory (ROM). The various processes and functions described herein may either be part of the micro instruction code or part of an application program (or a combination thereof) which is executed via the operating system.

It is to be further understood that because some of the constituent device components and method steps depicted in the accompanying figures may be implemented in software, the actual connections between the device components (or the process steps) may differ depending upon the manner in which the present disclosure is programmed. Given the teachings of the present disclosure provided herein, one of ordinary skill in the related art will be able to contemplate these and similar implementations or configurations of the present disclosure.

In the preferred embodiment, the sensors 100 are comprised cameras mounted on an exterior surface of the vehicle. For instance, in the preferred embodiment, the cameras 100 comprise left side cameras 100L mounted on a left side of the vehicle 104 and right side cameras 100R mounted on the right side of the vehicle 104. The side cameras 100L, 100R are positioned to provide images of lane markings 200. Additionally, in the preferred embodiment, a front camera 100F is mounted at a forward position of the vehicle 10. The present disclosure should not be limited to this embodiment. The sensors can also consist of a radar systems, night vision cameras, lasers systems, electro-magnetic sensors or other known devices capable of providing lane marking information to the central processor.

Frame grabbers are used to acquire images. The side cameras 100L, 100R, 100F are arranged to capture an image at assigned distance intervals. For instance, the cameras 100L, 100R, 100F may be set to capture one image for every one meter the vehicle 104 travels. The side cameras 100L, 100R are synchronized so that there is some duplication within the images. For instance, in the preferred embodiment, approximately sixty percent of the images captured by the left cameras 100L will be duplicative. The duplication of areas of the images allows the computer processor 102 to monitor the continuity of the lane markings 180. In this way, the computer processor 102 is able to recognize if the vehicle 104 switched lanes. Additionally, by measuring the continuity of lane markings 180, the computer processor 102 can recognize if there has been a change in the number of lanes on the roadway, or if there is a merger between adjacent lanes approaching. At least one sensor 100 is mounted on the vehicle 104 and is configured to identify and map the location of vehicles in surrounding lanes. The at least one sensor 100 may consist of a radar system, night vision cameras, laser systems, electromagnetic sensors, or other known devices capable of identifying surrounding vehicles. In one embodiment, the at least one sensor 100 is integrated with the cameras 100L, 100R, 100F.

A locational information device 150, such as a Global Positioning System (GPS), also is provided. The GPS 150 is connected to a communication network, such as a satellite relay or wireless network 160, to determine the exact position of the vehicle 10 within a network of roads. The GPS 150 has a display screen 152 visible to the operator of the vehicle 10 displaying the vehicle's 104 position on the network of roads. The GPS 150 further has a user interface, such as a touch screen, to allow the vehicle operator to enter a driving destination. The display screen displays detailed driving instructions to direct the driver to a specified destination. Additionally, the GPS 150 gives verbal cues and maps to inform the driver of impending driving maneuvers.

The control unit 102 collects and synchronizes information from the sensors 100 and the GPS 150. The control unit 102 extracts information from the GPS 150 relating to the exact position of the vehicle 104 within the network of roads. The control unit 104 also obtains information relating to the vehicle's 104 speed and the distance until a driving maneuver is required.

The sensors 100 provide the control unit 102 with continuous data. Specifically, the sensors 100 provide information relating to the number of lanes on the roadway and the vehicle's 104 relative position among the lanes.

The control unit 102 analyzes the data from the sensor 100 and the GPS 150 to inform the operator if a lane change is necessary. The control unit 102 and the GPS 150 will determine the next driving maneuver and whether there is a preferred or necessary lane for the driving maneuver. The control unit 102 will compare this information to the lane position data from the sensors 100. In the event that the driver occupies the preferred lane, the external synchronization device will not signal the operator.

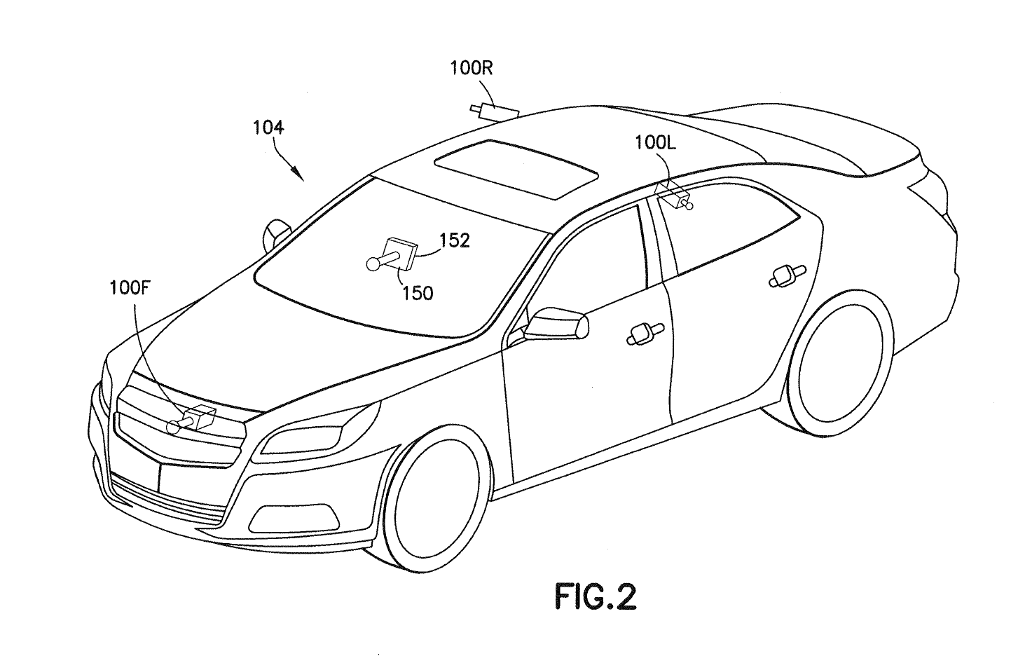

If the vehicle 104 is not in the preferred lane, the control unit 102 will signal the driver and inform the driver of the preferred lane. The signal is typically in the form of an audible sound. However, a visual signal can also be used to alert the operator of a required lane change. The visual signal can also be integrated into a map shown on the display 152. Additionally, based on the speed of the vehicle 104, the control unit 102 will inform the operator that a maneuver is required at a predetermined distance. For instance, a vehicle 104 traveling sixty-five miles per hour will need more time to switch lanes than a vehicle 104 traveling fifty miles per hour. Further, a vehicle 104 exhibiting signs of ‘stop-and-go” traffic (i.e. slow, short-distance travel followed by complete slowdown), will be given a longer distance to switch lanes due to the difficulty and complexity involved with switching lanes during a traffic situation.
With reference to FIG. 2 a method of the present invention will now be disclosed. A user inputs a destination into the location information system 150 (step 200). The location information system 150 operates a signal receiver to determine the current vehicle location (step 202). The at least one sensor 100 determines the lane position of the vehicle 104 within a series of lanes (step 204). Using the information from the at least one sensor 100, the location information system 150 develops a route to the destination (step 206). When a driving maneuver such as a turn is required, the control unit 102 gathers information from the at least one sensor 100 and the location information system 150 to determine if the vehicle 104 is in the proper lane (step 208). If the current vehicle lane is the appropriate lane for the turn, the location information system 150 will issue an instruction to the driver to turn (step 210). If the vehicle 104 is not in the appropriate lane for a turn, the control unit will gather information from the sensor 100 to determine if the appropriate lane is occupied by another vehicle. If the appropriate lane is not occupied, the location information system 150 will issue a lane change instruction (step 212). If the lane is occupied, the location information system 150 will alert the driver to the existence of the other vehicle. Once the vehicle 104 has moved into the proper lane, the location information system 150 will issue the turn instruction (step 210). The method will repeat until the vehicle has reached the destination.

While the disclosure has been shown and described with reference to certain preferred embodiments thereof, it will be understood by those skilled in the art that various changes in form and detail may be made therein without departing from the spirit and scope of the disclosure as defined by the appended claims.

What is claimed is:

1. A method for instructing a driver as to which lane to utilize along a route to a specified destination, the method comprising:
operating a signal receiver on a vehicle for receiving, from a location information system, signals that are indicative of a current vehicle location;
using at least one sensor on the vehicle to identify a current lane position of the vehicle along a route segment currently occupied by the vehicle;
determining whether a lane change is necessary for a next one of the turns along the route based on the current lane position determined by the sensor on the vehicle; and
issuing lane change instructions before the next turn when a lane change is determined to be necessary.

2. The method of claim 1, further comprising inputting the specified destination into an input device on the vehicle.

3. The method of claim 2, further comprising calculating a travel route based on the current vehicle location and the specified destination, the travel route comprising a plurality of route segments and turns between adjacent route segments

4. The method of claim 2, further comprising measuring a current vehicle speed and issuing the lane change instructions sufficiently before the next turn as a function of the vehicle speed.

5. The method of claim 2, further comprising using the sensor on the vehicle to determine proximity of the vehicle to other vehicles and issuing in the lane change instructions as a function of the proximity of the vehicle to the other vehicles.

6. The method of claim 2, wherein the steps of issuing lane change instructions and issuing turn instructions comprise issuing audible instructions.

7. The method of claim 2, further comprising issuing turn instructions before the next turn.

8. The method of claim 1, wherein the step of using at least one sensor on the vehicle to identify a current lane position comprises using at least one camera on the vehicle to identify the current lane position.

9. The method of claim 1, wherein the step of using at least one sensor on the vehicle to identify a current lane position comprises using at least one electro-magnetic sensor on the vehicle to identify the current lane position.

10. The method of claim 1, further comprising updating the current lane position after issuing the lane change instructions and reissuing the lane change instruction if the current lane position has not changed.

11. A route guidance system for a vehicle, comprising:
a signal receiver for receiving, from a location information system, a signal indicative of a current vehicle location;
a route calculator for calculating a route to the destination based on the current vehicle location, the route comprising a plurality of route segments and turns between adjacent route segments;
at least one sensor to identify a current lane position of the vehicle along the route segment currently occupied by the vehicle and to generate a current lane position signal;
at least one output device for generating route guidance instructions; and
a control unit connected to the route calculator, the sensor and the output device, the control unit being operative for determining whether a lane change is necessary for a next one of the turns along the route based on the current lane position determined by the sensor and issuing lane change instruction signals to be outputted by the output device sufficiently before the next turn when a lane change is determined to be necessary.

12. The route guidance system of claim 11, wherein the user input device is a touch screen monitor.

13. The route guidance system of claim 11, wherein the at least one sensor to identify a current lane position of the vehicle comprises at least one on board camera.

14. The route guidance system of claim 11, wherein the at least one sensor to identify a current lane position of the vehicle comprises at least one electromagnetic sensor for identifying lane markings.

15. The route guidance system of claim 11, further comprising a speed sensor operatively connected to the control unit, the control unit issuing the lane change instruction signals as a function of vehicle speed sensed by the speed sensor.

16. The route guidance system of claim 11, further comprising a vehicle proximity sensor for sensing proximity of the vehicle to at least one other vehicle, the control unit issuing the lane change instruction signals as a function of the proximity of the vehicle to the at least one other vehicle.

17. The route guidance system of claim 11, wherein the output device comprises a speaker for outputting an audible signal.

18. The route guidance system of claim 12, wherein the signal receiver is a GPS receiver for receiving a signal from a GPS satellite.

19. The route guidance system of claim 12, further comprising a user input device for inputting a destination.

20. A route guidance system for a vehicle, comprising:
a signal receiver for receiving, from a location information system, a signal indicative of a current vehicle location;
a route calculator for calculating a route to the destination based on the current vehicle location, the route comprising a plurality of route segments and turns between adjacent route segments;
at least one sensor to identify a current lane position of the vehicle along the route segment currently occupied by the vehicle and to generate a current lane position signal;
at least one output device for generating route guidance instructions;
a speed sensor for determining the speed of the vehicle;
a vehicle proximity sensor for sensing the proximity of the vehicle to at least one other vehicle;
a user input device for inputting a destination; and
a control unit connected to the route calculator, the sensor, the output device, the speed sensor, the vehicle proximity sensor, and the user input device, the control unit being operative for determining whether a lane change is necessary for a next one of the turns along the route based on the current lane position determined by the sensor and as a function of vehicle speed sensed by the vehicle sensor, the proximity of the vehicle to the at least one other vehicle, and issuing lane change instruction signals to be outputted by the output device sufficiently before the next turn when a lane change is determined to be necessary.
